(19) United States
(12) Patent Application Publication
(10) Pub. No.: US 2006/0050788 A1
(43) Pub. Date: Mar. 9, 2006

(54) Method and device for computer-aided motion estimation

(76) Inventor: Axel Techmer, Munchen (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/143,890

(22) Filed: Jun. 2, 2005

(30) Foreign Application Priority Data
Jun. 2, 2004 (DE) 10 2004 026 782.0

(51) Int. Cl. H04N 7/12; H04N 11/04; H04B 1/66; H04N 11/02

(52) U.S. Cl. 375/240.12

(57) ABSTRACT

A method and a device for computer-aided motion estimation in at least two temporally successive digital images with pixels to which coding information is assigned are provided, the motion being estimated on the basis of the spatial distribution of feature points.

### BACKGROUND

One embodiment of the invention relates to a method and a device for computer-aided motion estimation in at least two temporally successive digital images, a computer-readable storage medium and a computer program element.

Development in the field of mobile radio telephones and digital cameras, together with the widespread use of mobile radio telephones and the high popularity of digital cameras, has led to modern mobile radio telephones often having built-in digital cameras. In addition, services such as, for example, the multimedia message service (MMS) are provided which enable digital image communications to be transmitted and received using mobile radio telephones suitable for this.

Typically, the components of mobile radio telephones which enable digital images to be recorded do not afford high performance compared with commercially available digital cameras.

The reasons for this are for example that mobile radio telephones are intended to be cost-effective and small in size.

The resolution of digital images that can be recorded by means of mobile radio telephones with a built-in digital camera is too low for some purposes.

By way of example, it is possible, in principle, to use a mobile radio telephone with a built-in digital camera to photograph printed text and to send it to another mobile radio telephone user in the form of an image communication by means of a suitable service, for example the multimedia message service (MMS), but the resolution of the built-in digital camera is insufficient for this in the case of a present-day commercially available device in a medium price bracket.

However, it is possible to generate, from a suitable sequence of digital images which in each case represent a scene from a respective recording position, a digital image of the scene which has a higher resolution than that of the digital images of the sequence of digital images.

This possibility exists for example when the positions from which digital images of a sequence of digital images of the scene have been recorded differ in a suitable manner.

The recording positions, that is, the positions from which the digital images of the sequence of digital images of the scene have been recorded, may differ in a suitable manner for example when the plurality of digital images has been generated by recording a plurality of digital images by means of a digital camera held manually over a printed text.

In this case, the differences in the recording positions that are generated as a result of the slight movement of the digital camera that arises as a result of shaking of the hand typically suffice to enable the generation of a digital image of the scene with high resolution.

However, this necessitates calculation of the differences in the recording positions.

If a first digital image is recorded from a first recording position and a second digital image is recorded from a second recording position, an image content constituent, for example an object of the scene, is represented in the first digital image at a first image position and in a first form, which is taken to mean the geometrical form hereinafter, and is represented in the second digital image at a second image position and in a second form.

The change in the recording position from the first recording position to the second recording position is reflected in the change in the first image position to the second image position and the first form to the second form.

Therefore, a calculation of a recording position change which is necessary for generating a digital image having a higher resolution than that of the digital images of the sequence of digital images can be effected by calculating the change in the image position at which image content constituents are represented and the form in which image content constituents are represented.

If an image content constituent is represented in a first image at a first (image) position and in a first form and is represented in a second image at a second position and in a second form, then a motion of the image content constituent or an image motion will be how this is referred to hereinafter.

Not only is it possible for the position of the representation of an image content constituent to vary in successive images, but the representation may also be distorted or its size may change.

Moreover, the representation of an image content constituent may change from one digital image of the sequence of digital images to another digital image of the sequence of digital images, for example the brightness of the representation may change.

Only the temporal change in the image data can be utilized for determining the image motion. However, this temporal change is caused not just by the motion of objects in the vicinity observed and by the observer's own motion, but also by the possible deformation of objects and by changing illumination conditions in natural scenes.

In addition, disturbances have to be taken into account, for example, vibration of the camera or noise in the processing hardware.

Therefore, the pure image motion can only be obtained with knowledge of the additional influences or be estimated from assumptions about the latter.

For the generation of a digital image having a higher resolution than that of the digital images of the sequence of digital images, it is very advantageous for the calculation of the motion of the image contents from one digital image of the sequence of digital images to another digital image of the sequence of digital images to be effected with subpixel accuracy.

Subpixel accuracy is to be understood to mean that the motion is accurately calculated over a length shorter than the distance between two locally adjacent pixels of the digital images of the sequence of digital images.

Hereinafter an image is always to be understood to mean a digital image.

One conventional method for carrying out motion estimation with subpixel accuracy is the determination of the optical flow J. J. Gibson, The Perception of the Visual World, Boston, 1950.

The optical flow relates to the image changes, that is, to the changes in the representation of image contents of an image of the sequence of digital images with respect to the temporally succeeding or preceding image of the sequence of digital images which arise from the motion of the objects and the observer's own motion. The image motions generated can be interpreted as velocity vectors which are attached to the pixels. The optical flow is understood to mean the vector field of these vectors. In order to determine the motion components, assumptions about the temporal change in the image values are usually made.

I(x, y, t) designates the time-dependent, two-dimensional image. I(x, y, t) is an item of coding information which is assigned to the pixel at the location (x, y) of the image at the instant t.

Coding information is to be understood hereinafter to mean an item of brightness information (luminance information) and/or an item of color information (chrominance information) which is assigned in each case to one pixel or a plurality of pixels.

A sequence of digital images is expressed as a single, time-dependent image, that is, that the first image of the sequence of digital images corresponds to a first instant t₁, the second image of the sequence of digital images corresponds to a second instant t₂ and so on.

I(x, y, t₁) is thus for example the gray-scale value of an image at the location (x, y) of the image of the sequence of digital images which corresponds to the first instant t₁; for example, it was recorded at the first instant t₁.

The change for a pixel which the latter experiences in the time dt with rate (dx, dy) can be expressed by means of development into a Taylor series

$$I ( x + ⅆ x , y + ⅆ y , t + ⅆ t ) = I ( x , y , t ) + \frac{\partial I}{\partial x} ⅆ x + \frac{\partial I}{\partial y} ⅆ y + \frac{\partial I}{\partial t} ⅆ t + … \qquad ( 1 )$$

For the determination of the optical flow, the assumption is made that the image values remain constant along the motion direction. This is formulated by the equation
I(x+dx, y+dy, t+dt)=I(x, y, t) (2)
from which the equation

$$\frac{\partial I}{\partial x} ⅆ x + \frac{\partial I}{\partial y} ⅆ y + \frac{\partial I}{\partial t} ⅆ t + … = 0 \qquad ( 3 )$$

follows, wherein as in equation (1), the three dots symbolize the terms having higher derivatives than the first partial derivatives of the function I.

If equation (3) is divided by the expression dt and the terms having higher derivatives than the first partial derivatives of I are disregarded, this results in the equation

$$\frac{\partial I}{\partial t} = - \frac{\partial I}{\partial x} \frac{ⅆ x}{ⅆ t} - \frac{\partial I}{\partial y} \frac{ⅆ y}{ⅆ t} . \qquad ( 4 )$$

Disregarding the higher derivatives leads to errors if the image motion is large in relation to the pixel grid.

The vector

$$[ \frac{ⅆ x}{ⅆ t} , \frac{ⅆ y}{ⅆ t} ]$$

specifies the components of the optical vector field, and is usually designated by [u, v].

The following thus holds true for equation (4)

$$\frac{\partial I}{\partial t} = - \frac{\partial I}{\partial x} u - \frac{\partial I}{\partial y} v . \qquad ( 5 )$$

This equation is deemed to be a fundamental equation of the optical flow.

In order that u and v can be determined unambiguously, it is known to make further assumptions about the temporal change in the image data.

In accordance with B. K. P Horn and B. G. Schunck, Determining Optical Flow, Artificial Intelligence, 1981, an additional assumption taken in this respect is that the optical flow is smooth.

Both assumptions together lead to a minimization problem, which is formulated as follows:

$$( \hat{u} , \hat{v} ) = {arg min}_{u , v} {\int \int }_{x , y} [ ( \frac{\partial I}{\partial t} + \frac{\partial I}{\partial x} u + \frac{\partial I}{\partial y} v ) + λ ( {( \frac{\partial u}{\partial x} )}^{2} + {( \frac{\partial u}{\partial y} )}^{2} + {( \frac{\partial v}{\partial x} )}^{2} + {( \frac{\partial v}{\partial y} )}^{2} ) ] ⅆ x ⅆ y \qquad ( 6 )$$

The first term of the integral corresponds to the fundamental equation of the optical flow (5) and the second term represents the smoothness condition in accordance with B. K. P Horn and B. G. Schunck, Determining Optical Flow, Artificial Intelligence, 1981.

This clearly means that the first term has the effect that the vector field which solves the minimization problem given by equation (6) fulfils equation (5) as well as possible. The smoothness condition has the effect that the partial derivatives of the vector field which solves the minimization problem given by equation (6) with respect to the position variables x and y are as small as possible.

The minimization problem given by equation (6) can be solved by means of a variation calculation approach.

A system of linear equations is solved in this case, the number of unknowns in the system of linear equations being twice the number of pixels.

In B. K. P Horn and B. G. Schunck, Determining Optical Flow, Artificial Intelligence, 1981, an iterative procedure in accordance with the so-called Gauss-Seidel method is proposed for solving the system of linear equations.

In accordance with B. Lucas, T. Kanade, An Iterative Image Registration Technique with an Application to Stero Vision, 7th International Joint Conf. on Artificial Intelligence (IJCAI), pp. 674-679, 1981, the condition that adjacent pixels must have the same motion vector is used as a second assumption for the determination of the optical flow.

It can be deduced from equation (5) that this assumption must be fulfilled for at least two points.

However, a small local neighborhood of a pixel is usually used.

The determination of u, v can be formulated under this assumption as a least squares problem:

$${\sum }_{x , y} {( \frac{\partial I}{\partial t} + \frac{\partial I}{\partial x} u + \frac{\partial I}{\partial y} v )}^{2} \to min . \qquad ( 7 )$$

This leads to the system of equations:

$$\begin{matrix}{\sum }_{x , y} {( \frac{\partial I}{\partial x} )}^{2} u + {\sum }_{x , y} ( \frac{\partial I}{\partial x} \frac{\partial I}{\partial y} ) v = - {\sum }_{x , y} ( \frac{\partial I}{\partial t} \frac{\partial I}{\partial x} ) & ( 8 ) \\ {\sum }_{x , y} ( \frac{\partial I}{\partial x} \frac{\partial I}{\partial y} ) u + {\sum }_{x , y} {( \frac{\partial I}{\partial y} )}^{2} v = - {\sum }_{x , y} ( \frac{\partial I}{\partial t} \frac{\partial I}{\partial y} ) & ( 9 )\end{matrix}$$

The sums in the equations (7), (8) and (9) proceed over all x, y from the local neighborhood of the pixel that is used.

Through the evaluation of a local neighborhood, an optical flow vector is determined with subpixel accuracy in both of the methods explained above.

However, the following problems occur in both methods:
no motion can be determined in homogeneous regions since the required smoothness or the group formation does not yield additional information.
in both methods, the local and temporal derivatives are approximated by discrete differences, which may lead to a low accuracy.
problems arise if the motion is large in relation to the sampling time of the images. It is then no longer possible to straightforwardly disregard the higher derivatives in the Taylor series development. In this case, so-called block matching methods that are based on a correlation analysis often even lead to better results. These methods are comparable, in principle, with the approaches in accordance with B. Lucas, T. Kanade, An Iterative Image Registration Technique with an Application to Stero Vision, 7th International Joint Conf. on Artificial Intelligence (IJCAI), pp. 674-679, 1981.
the assessment of small local neighborhoods leads to a further problem for example for photographing text documents. Even if the intensity pattern is high in contrast within the local neighborhood, ambiguities can arise because the pattern is repeated in the vicinity of the local neighborhood. This occurs, for example, in the case of texts since there are no intensity differences between the letters and letters are formed from the same geometrical forms. The correlation analysis especially leads to errors here.
contrary to the assumption in accordance with B. K. P Horn and B. G. Schunck, Determining Optical Flow, Artificial Intelligence, 1981; B. Lucas, T. Kanade, An Iterative Image Registration Technique with an Application to Stero Vision, 7th International Joint Conf. on Artificial Intelligence (IJCAI), pp. 674-679, 1981, it cannot be expected in general (if, for example, moving objects are present in the image) that the optical flow will proceed in locally constant or smooth fashion. Rather, it must be regarded as smooth in portions since discontinuities occur, for example, at object boundaries. These discontinuities have to be taken into account in the determination of the optical flow.

Numerous studies are concerned with the problem of the optical flow taking account of discontinuities, obscurations, etc.

For the above-described application in which a high resolution image is to be generated from a low resolution sequence of digital images generated by means of a digital camera, these approaches are not necessary, however, since, in the case of the above application, only a motion of the camera is present and the above assumptions are thereforee fulfilled to an approximation.

Consequently, the use of these approaches for a method would lead to unnecessarily high complexity of the method and thus to a low efficiency of the method.

The problem of unambiguously determining the optical flow in homogeneous image sections or along extended horizontal or vertical edges can be avoided by the optical flow not being implemented at all pixels but rather at points with significant image values (see, for example, J. Shi, C. Tomasi, Good Features to Track, IEEE Conf. on Computer Vision and Pattern Recognition (CVPR94), 1994).

This has the effect that only a thinned optical flow is present. The problem of the approximation of the derivatives by discrete differences in the case of fast motions can be reduced by using image pyramids (see, for example, W. Enkelmann, Investigations of multigrid algorithms for the estimation of optical flow fields in image sequences, Computer Vision, Graphics and Image Processing, 150-177, 1988).

In the case of the above methods, motion vectors are determined as individual pixels on the basis of the fundamental equation of the optical flow (5). A local vicinity is taken into account in the determination. The calculations of the motion vectors at the individual pixels are effected independently of one another.

This enables the determination of different motions generated by different objects.

It is furthermore known, under the presumption that the scene represented by the images of the sequence of digital images is static and the image motion is caused only by the observer, to determine a motion model for all pixels on the basis of the fundamental equation of the optical flow (5) from the coding information of the images.

This is explained below.

If u(x, y, t) and v(x, y, t) designate the motion at a pixel (x, y) at an instant t then the following holds true:
Iₓ(x, y, t)u(x, y, t)+I_{y}(x, y, t)v(x, y, t)+Iₜ(x, y, t)=0 (10)
(see Equation (5)).

Iₓ(x, y, t), I_{y}(x, y, t), Iₜ(x, y, t) designate the partial derivatives of the function I(x, y, t) with respect to the variable x and the variable y and the variable z at the location (x, y) at the instant t.

Various motion models can be used for u(x, y, t) and v(x, y, t) in order to model the motion sought in the image as well as possible.

For an affine motion model, the following holds true for example:
u(x, y, t)=a₀x+a₁y+a₂ (11)
v(x, y, t)=a₃x+a₄y+a₅ (12)
The determination of u(x, y, t) and v(x, y, t) with the aid of equation (10) may be formulated, for example, as the minimization of a square error:

$$\underline{\hat{a}} = {arg min}_{\underline{a}} {\sum }_{y} {\sum }_{x} {( {I}_{x} ( {a}_{0} x + {a}_{1} y + {a}_{2} ) + {I}_{y} ( {a}_{3} x + {a}_{4} y + {a}_{5} ) + {I}_{t} )}^{2} \qquad ( 13 )$$

In the solution of the minimization problem given by (13), the parameters a₀, a₁, a₂, a₃, a₄ and a₅ from equations (11) and (12) are determined in the form of a optimum parameter vector

$$\underline{\hat{a}} = ( \begin{matrix}{a}_{0} \\ ⋮ \\ {a}_{5}\end{matrix} ) .$$

This method also leads to poor results in the case of large motions because ignoring the higher derivatives in the Taylor development leads to errors.

Therefore, in accordance with the prior art, a hierarchical procedure is employed in the case of this method, too.

Firstly, the motion is determined at a low resolution level since the size of the motion is also reduced by reducing the resolution. The resolution is then increased progressively up to the original resolution.

Moreover, the quality of the motion estimation is improved by means of an iterative procedure.

FIG. 11 illustrates a flow diagram 1100 of a method for parametric motion determination that is disclosed in Y. Altunbasak, R. M. Mersereau, A. J. Patti, A Fast Parametric Motion Estimation Algorithm with Illumination and Lens Distortion Correction, IEEE Transactions on Image Processing, 12(4), pp. 395-408, 2003, for example.

For a plurality of images 1101, a first loop 1102 is implemented over all resolution levels, that is, over all resolution stages.

Within each iteration of the first loop 1102, the image in the current resolution level is subjected to low-pass filtering in step 1103 and is subsequently subsampled in step 1104.

The local gradients, that is, clearly the image directions with the greatest rise in brightness, are determined in step 1105.

Afterward, a second loop 1106 is implemented within each iteration of the first loop 1102.

Within each pass through the second loop, firstly step 1107 involves calculating the temporal gradient, that is, clearly the change in brightness at a pixel from the image that was recorded at the instant t to the image that was recorded at the instant t+1.

In step 1108, within the first iteration of the second loop 1106 for the first resolution level, a first parameter vector a₀ is calculated from the coding information I(x, y, t) of the image that was recorded at the instant t and the coding information I(x, y, t+1) of the image that was recorded at the instant t+1, for example by means of a least squares estimation as in the case of the method described above, which determines the parametric motion model.

The quality of the current motion model which is determined by the currently calculated parameter vector is measured in step 1109.

If the quality has not improved, the current iteration of the second loop 1106 is ended.

If the quality has improved, in step 1111, from the coding information I(x, y, t+1) of the image that was recorded at the instant t+1, by means of the motion model which is determined by the currently calculated parameter vector, a compensated coding information item I¹(x, y, t+1) of the image that was recorded at the instant t+1 is determined by compensation and the currently calculated parameter vector is accepted in step 1112.

The current iteration of the second loop 1106 is subsequently ended.

In all subsequent iterations of the second loop 1106, the procedure is analogous to the first iteration of the second loop 1106 for the first resolution level except that in each case instead of the coding information I¹(x, y, t+1) the compensated coding information from the last iteration I¹(x, y, t+1), I²(x, y, t+1), . . . is used in order to determine parameter vectors a¹, a², . . . .

The loop 1106 is implemented until a predetermined termination criterion is satisfied, for example the least squares error lies below a predetermined limit.

If the determination criterion is satisfied, the current iteration of the first loop 1102 is ended.

If an iteration of the first loop 1102 has been implemented for each desired resolution level, then a parameter vector a is calculated from the calculated parameter vectors a₀, a₁, a₂, . . . , and the motion 1113 is deemed to have been determined.

This method is known by the designation “parametric motion determination”.

It is furthermore known to determine image motion by means of temporal tracking of objects.

Numerous methods exist which presuppose explicit model knowledge about the object and for which a preceding step of object detection is necessary (see, for example, D. Noll, M. Werner, and W. von Seelen., Real-Time Vehicle Tracking and Classification, Proceedings of the Intelligent Vehicles '95, pp. 101-106, 1995).

However, these methods are not suitable for applications such as the one described above, in which a high resolution image is to be generated from a low resolution sequence of digital images generated by means of a digital camera, since these methods have a severe limitation of the variation possibilities, that is, of the image alterations that can be ascertained.

Another group of methods uses a contour of an object to be tracked. These methods are known by the key words “active contours” or “snakes”.

These approaches are not suitable either for applications such as the one described above, in which a high resolution image is to be generated from a low resolution sequence of digital images generated by means of a digital camera, since in general no object contour is present.

A further group of customary methods for object tracking uses a representation of objects by feature points and tracks these points over time, that is, over the sequence of digital images.

The points are firstly tracked independently of one another.

A motion model that enables the displacements of the individual points is subsequently ascertained.

For the motion of the individual object points, it is possible to use methods for determining the optical flow. The disadvantages of the optical flow that have already been discussed thus occur here with the addition that the evaluation of homogeneous regions is avoided by the selection of feature points.

It is also possible to determine a uniform motion for all object points.

In contrast to the methods based on the optical flow, there is the problem here that the parameters of the motion model can no longer be determined directly by means of a system of linear equations, rather an optimization over the entire parameter range is necessary.

In the case of the method by Werner et al. disclosed in Martin Werner, Objektverfolgung und Objekterkennung mittels der partiellen Hausdorffdistanz, [Object tracking and object identification by means of the partial Hausdorff distance], Faculty for Electrical Engineering, Bochum, Ruhr University, 1998, a motion model is determined by means of a minimization of the Hausdorff distance. This requires carrying out a minimization over all motion parameters, which leads to a considerable computational complexity.

An alternative approach, described by Capel et al. in D. Capel, A. Zisserman, Computer vision applied to super resolution, Signal Processing Magazine, IEEE, May 2003, pages 75-86, Vol. 20, Issue: 3, ISSN: 1053-5888, consists in dividing the object features into small subsets. For each of these subsets, firstly a dedicated motion model is determined in which corresponding object features are sought at the instant t1 and t2. Corresponding object features are determined by comparing the intensity patterns. By means of these corresponding points, a motion model can be determined directly by means of least squares approach. The model which permits the best assignment for all object features is ultimately selected from the motion models of the subsets. An assessment for the best assignment is for example the minimization of the sum of absolute image differences.

In order to reduce the complexity for determining corresponding points, it is necessary in the case of this method, however, to determine a minimum number of subsets with a minimum number of feature points. Therefore, inaccuracies and ambiguities such as have already been described above with reference to methods based on the optical flow occur in this method.

A further possibility for determining a motion model for an object representation by feature points is described in A. Techmer, Contour-Based Motion Estimation and Object Tracking for Real-Time Applications, IEEE International Conference on Image Processing (ICIP 2001), pp. 648-651, 2001. A contour-based determination of the image motion is presented here. The motion is calculated by a comparison of contour point positions and contour forms. The approach may additionally be extended to object tracking. The method is based solely on the evaluation of distances and thus on the evaluation of the geometrical form of objects. This makes the method less sensitive toward illumination or exposure changes in comparison with approaches that assess the intensity pattern. The determination of the motion model only requires a variation over the two translation components of the motion. The remaining parameters can be determined directly by means of a least squares estimation. This achieves a substantial reduction of the computational complexity in comparison with methods requiring a variation over all parameters of the motion model (see, for example, Martin Werner, Objektverfolgung und Objekterkennung mittels der partiellen Hausdorffdistanz, [Object tracking and object identification by means of the partial Hausdorff distance], Faculty for Electrical Engineering, Bochum, Ruhr University, 1998).

These approaches have the disadvantage that motion models such as affine transformation models, for example, have to be determined which have a high number of degrees of freedom.

William H. Press, et al., Numerical Recipes in C, ISBN: 0-521-41508-5, Cambridge University Press discloses interpolating a function bicubically.

### SUMMARY

One embodiment of the invention ascertains the image motion in at least two temporally successive digital images efficiently and with high accuracy. One embodiment includes a method and a system for ascertaining the image motion of at least two temporally successive digital images, a computer-readable storage medium and a computer program element.

Image motion in a first image and a second image that temporally follows the first image is to be understood to mean that an image content constituent is represented in the first image at a first (image) position and in a first form and is represented in the second, following image at a second position and in a second form, the first position and the second position or the-first form and the second form being different.

Efficiently means, for example, that the calculation can be implemented by means of simple and cost-effective hardware in a short time.

By way of example, the intention is that the hardware required for the calculation can be provided in a cost-effective mobile radio telephone.

As mentioned above, coding information is to be understood to mean brightness information (luminescence information) and/or an item of color information (chrominance information) which is in each assigned to a pixel.

In one embodiment, a method for computer-aided motion estimation in at least two temporally successive digital images with pixels to which coding information is assigned, is provided
a set of feature points of the first image being determined using a first selection criterion, a feature point of the first image being a pixel of the first image, in the case of which the coding information which is assigned to the pixel and the coding information which is assigned in each case to the pixels in a vicinity of the pixel satisfy the first selection criterion;
a set of feature points of the second image being determined using a second selection criterion, a feature point of the second image being a pixel of the second image, in the case of which the coding information which is assigned to the pixel and the coding information which is assigned in each case to the pixels in a vicinity of the pixel satisfy the second selection criterion;
an assignment of each feature point of the first image to a respective feature point of the second image is determined on the basis of the spatial distribution of the set of feature points of the first image and on the basis of the spatial distribution of the set of feature points of the second image; and
the motion is estimated with subpixel accuracy on the basis of the assignment.

Furthermore, in one embodiment, a computer program element is provided, which, after it has been loaded into a memory of a computer, has the effect that the computer carries out the above method.

Furthermore, in one embodiment, a computer-readable storage medium is provided, on which a program is stored which enables a computer, after it has been loaded into a memory of the computer, to carry out the above method.

Furthermore, in one embodiment, a device is provided, which is set up such that the above method is carried out.

In one case, the motion determination is effected by means of a comparison of feature positions.

In one embodiment, features are determined in two successive images and assignment is determined by attempting to determine those features in the second image to which the features in the first image respectively correspond. If that feature in the second image to which a feature in the first image corresponds has been determined, then this is interpreted such that the feature in the first image has migrated to the position of the feature in the second image and this position change, which corresponds to an image motion of the feature, is calculated. Furthermore, a uniform motion model which models the position changes as well as possible is calculated on the basis of the position changes of the individual features.

Therefore, an assignment is fixedly chosen and a motion model is determined which best maps all feature points of the first image onto the feature points—respectively assigned to them—of the second image in a certain sense, for example in a least squares sense as described below.

In one case, a distance between the set of feature points of the first image that is mapped by means of the motion model and the set of the feature points of the second image is not calculated for all values of the parameters of the motion model. Consequently, a low computational complexity is achieved in the case of the method provided.

Features are points of the image which are significant in a certain predetermined sense, for example edge points.

An edge point is a point of the image at which a great local change in brightness occurs; for example, a point whose neighbor on the left is black and whose neighbor on the right is white is an edge point.

Formally, an edge point is determined as a local maximum of the image gradient in the gradient direction or is determined as a zero crossing of the second derivative of the image information.

Further image points that can be used as feature points in the method provided are, for example:
gray-scale value corners, that is, pixels which have a local maximum of the image gradient in the x and y direction.
corners in contour profiles, that is, pixels at which a significant high curvature of a contour occurs.
pixels with a local maximum filter response in the case of filtering with local filter masks (for example, sobel operator, gabor functions, etc.).
pixels which characterize the boundaries of different image regions. These image regions are generated, for example, by image segmentations such as “region growing” or “watershed segmentation”.
pixels which describe centroids of image regions, as are generated for example by the image segmentations mentioned above.

The positions of a set of features are determined by a two-dimensional spatial feature distribution of an image.

In the determination of the motion of a first image and a second image in accordance with one method provided, the spatial feature distribution of the first image is compared with the spatial feature distribution of the second image.

In contrast to a method based on the optical flow, in the case of one method provided the motion is not calculated on the basis of the brightness distribution of the images, but rather on the basis of the spatial distribution of significant points.

In addition to the above-described “super-resolution”, that is, the generation of high resolution images from a sequence of low resolution images, the motion estimation method provided may furthermore be used
for structure-from-motion methods that serve to infer the 3D geometry of the vicinity from a sequence of images recorded by a moving camera;
for methods for generating mosaic images in which a large high resolution image is assembled from individual high resolution smaller images; and
for video compression methods in which an improved compression rate can be achieved by means of a motion estimation.

One embodiment of the method provided is distinguished by its high achievable accuracy and by its simplicity.

It is not necessary for any spatial and temporal derivatives to be approximated, which is computationally intensive and typically leads to inaccuracies.

On account of the simplicity of one method provided, it is possible to implement the method in a future mobile radio telephone, for example, without the latter having to have a powerful and cost-intensive data processing unit.

In one case of the above method, the motion estimation based on the spatial distribution of the set of feature points of the first image and on the spatial distribution of the set of feature points of the second image is carried out by a feature point from the set of features of the second image being assigned to each feature point from the set of feature points of the first image.

In one embodiment, a feature point from the set of feature points of the first image is assigned to a feature point from the set of feature points of the second image with respect to which the feature point from the set of feature points of the first image has a minimum spatial distance which is determined from the coordinates of the feature point from the set of feature points of the first image and the coordinates of the feature point from the set of feature points of the second image.

In one case, the motion estimation can be carried out with low computational complexity. By way of example, the abovementioned assignment can be carried out with the aid of a distance transformation, for which efficient methods are known.

In one case of the above method, the determination of the set of feature points of the first image, the determination of the set of feature points of the second image and the motion estimation are effected with subpixel accuracy.

In one case of the above method, the motion estimation is effected by determination of a motion model.

In one case, a translation is determined prior to the determination of the motion model.

In one embodiment, which is described below, a translation is determined before the above-described assignment of the feature points of the first image to feature points of the second image is determined.

By determining a translation prior to the determination of the motion model, it is possible to increase the accuracy of the motion estimation with low computational complexity.

The translation can be determined with low computational complexity since a translation can be determined by means of a small number of motion parameters.

In one case, an affine motion model or a perspective motion model is determined.

The motion model is in one case determined iteratively.

In this case, in each iteration the assignment of each feature point of the first image to a respective feature point of the second image is fixedly chosen, but the assignments that are used in different iterations may be different.

As a result, it is possible to obtain a high accuracy.

In one case of the above method, the first selection criterion and the second selection criterion being chosen such that the feature points from the set of feature points of the first image are edge points of the first image and the feature points from the set of feature points of the second image are edge points of the second image.

In one case, the above method is used, in the case of a structure-from-motion method, in the case of a method for generating mosaic images, in the case of a video compression method or a super-resolution method.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates an arrangement in accordance with one exemplary embodiment of the invention.

FIG. 2 illustrates a flow diagram of a method in accordance with one exemplary embodiment of the invention.

FIG. 3 illustrates a flow diagram of a determination of a translation in accordance with one exemplary embodiment of the invention.

FIG. 4 illustrates a flow diagram of a determination of an affine motion in accordance with one exemplary embodiment of the invention.

FIG. 5 illustrates a flow diagram of a method in accordance with a further exemplary embodiment of the invention.

FIG. 6 illustrates a flow diagram of an edge detection in accordance with one exemplary embodiment of the invention.

FIG. 7 illustrates a flow diagram of an edge detection with subpixel accuracy in accordance with one exemplary embodiment of the invention;

FIG. 8A and FIG. 8B illustrate the results of a performance comparison of one embodiment of the invention with known methods.

FIG. 9 illustrates a flow diagram of a method in accordance with a further exemplary embodiment of the invention.

FIG. 10 illustrates a flow diagram of a determination of a perspective motion in accordance with one exemplary embodiment of the invention.

FIG. 11 illustrates a flow diagram of a known method for parametric motion determination.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

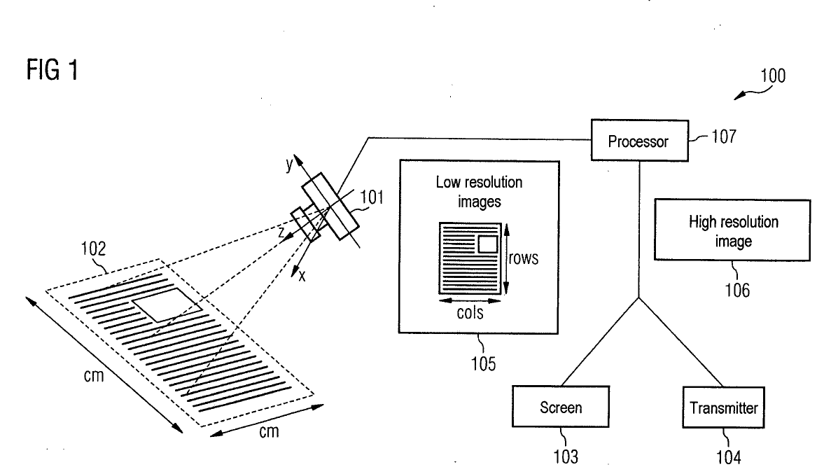

FIG. 1 illustrates an arrangement 100 in accordance with one exemplary embodiment of the invention.

A low resolution digital camera 101 is held over a printed text 102 by a user (not shown).

Low resolution is to be understood to mean a resolution which does not suffice to enable a digital image with this resolution of the printed text 102 which has been recorded by means of the digital camera 101 and is displayed on a screen to represent the text with sufficiently high resolution such that it can be read in a simple manner by a user or can be automatically processed further in a simple manner, for example in the case of optical pattern recognition, optical character recognition.

The printed text 102 may be for example a text printed on paper which the user wishes to send to another person.

The digital camera 101 is coupled to a (micro)processor 107.

The digital camera 101 generates a sequence of low resolution digital images 105 of the printed text 102. The recording positions of the digital images from the sequence of low resolution digital images 105 of the printed text 102 are different since the user's hand is not completely motionless.

The sequence of low resolution digital images 105 is fed to the processor 107, which calculates a high resolution digital image 106 from the sequence of low resolution digital images 105.

For this purpose, the processor 107 uses a method for ascertaining the image motion such as is described further below in exemplary embodiments.

The high resolution digital image 106 is displayed on a screen 103 and can be transmitted to another person by the user by means of a transmitter 104.

In an exemplary embodiment, the digital camera 101, the processor 107, the screen 103 and the transmitter 104 are contained in a mobile radio telephone.

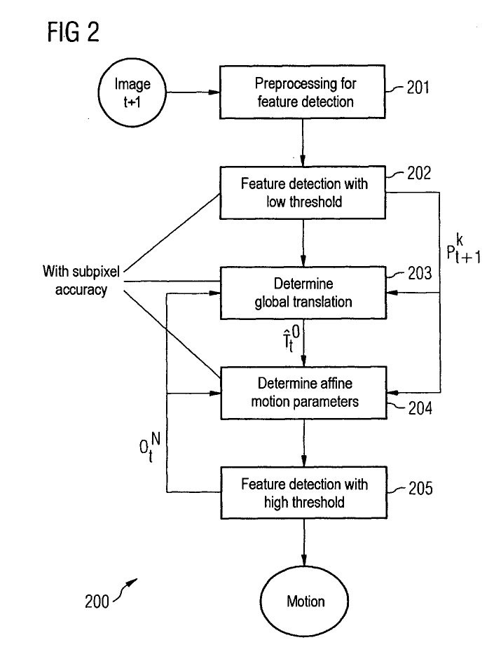

FIG. 2 illustrates a flow diagram 200 of a method in accordance with one exemplary embodiment of the invention.

The method explained below serves for calculating the motion in the sequence of low resolution images 105 that have been recorded by means of the digital camera 101. Each image of the sequence of low resolution images 105 is expressed by a function I(x, y, t), where t is the instant at which the image was recorded and I(x, y, t) specifies the coding information of the image at the location (x, y) which was recorded at the instant t.

It is assumed in this exemplary embodiment that no illumination fluctuations or disturbances in the process hardware occurred during the recording of the digital images.

Under this assumption, the following equation holds true for two successive digital images in the sequence of low resolution images 105 with the coding information I(x, y, t) and I(x, y, t+dt) occur respectively:
I(x+dx, y+dy, t+dt)=I(x, y, t) (14)
In this case, dt is the difference between the recording instants of the two successive digital images in the sequence of low resolution images 105.

Under the assumption that only one cause of motion exists equation (14) can also be formulated by
I(x, y, t+dt)=I(Motion(x, y, t), t) (15)
where motion (x, y, t) describes the motion of the pixels.

The image motion can be modeled for example by means of an affine transformation

$$[ \begin{matrix}x ( t + dt ) \\ y ( t + dt )\end{matrix} ] = [ \begin{matrix}{m}_{x 0} & {m}_{x 1} \\ {m}_{y 0} & {m}_{y 1}\end{matrix} ] [ \begin{matrix}x ( t ) \\ y ( t )\end{matrix} ] + [ \begin{matrix}{t}_{x} \\ {t}_{y}\end{matrix} ] , \qquad ( 16 )$$

An image of the sequence of low resolution digital images 105 is provided in step 201 of the flow diagram 200.

It is assumed that the digital image was recorded by means of the digital camera 101 at an instant t+1.

An image that was recorded at an instant τ is designated hereinafter as image τ for short.

Consequently, by way of example, the image that was recorded by means of the digital camera 101 at an instant t+1 is designated as image t+1.

It is furthermore assumed that a digital image that was recorded at an instant t is present, and that the image motion from the image t to the image t+1 is to be determined.

The feature detection, that is, the determination of feature points and feature positions, is prepared in step 202.

By way of example, the digital image is preprocessed by means of a filter for this purpose.

A feature detection with a low threshold is carried out in step 202.

This means that during the feature detection, a value is assigned to each pixel, and a pixel belongs to the set of feature points only when the value assigned to it lies above a certain threshold value.

In the case of the feature detection carried out in step 202, said threshold value is low, where “low” is to be understood to mean that the value is less than the threshold value of the feature detection carried out in step 205.

A feature detection in accordance with one embodiment of the invention is described further below.

The set of feature points that is determined during the feature detection carried out in step 202 is designated by Pₜ₊₁^{K}:

$${P}_{t + 1}^{K} = \{ {[ {P}_{t + 1 , x} ( k ) , {P}_{t + 1 , y} ( k ) ]}^{T} , 0 \leq k \leq K - 1 \} \qquad ( 17 )$$

In this case, Pₜ₊₁=[P_{t+1,x}(k) Pₜ₊1,y(k)]^{T} designates a feature point with the index k from the set of feature points Pₜ₊₁^{K} in vector notation.

The image information of the image t is written as function I(x, y, t) analogously to above.

A global translation is determined in step 203.

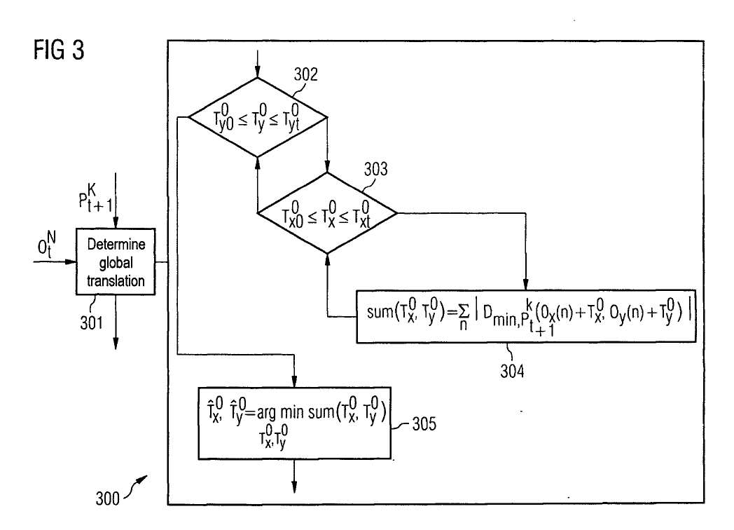

This step is described below with reference to FIG. 3.

Affine motion parameters are determined in step 204.

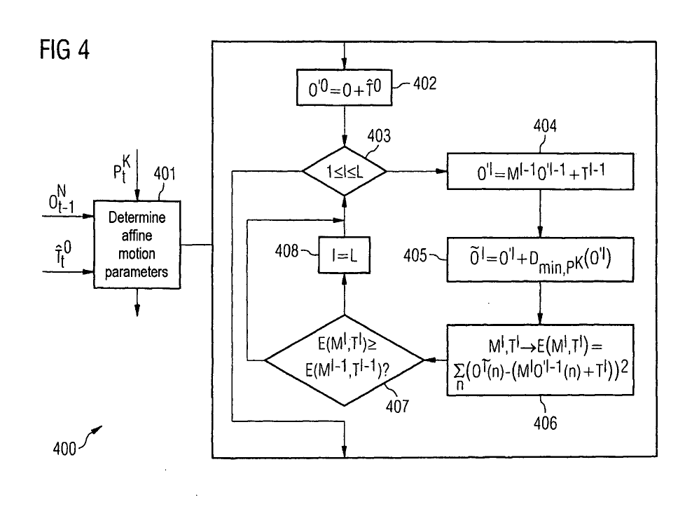

This step is described below with reference to FIG. 4.

A feature detection with a high threshold is carried out in step 205.

In other words, the threshold value is high during the feature detection carried out in step 205, where high is to be understood to mean that the value is greater than the threshold value of the feature detection with a low threshold value that is carried out in step 202.

As mentioned, a feature detection in accordance with one embodiment of the invention is described further below.

The set of feature points determined during the feature detection carried out in step 205 is designated by Oₜ₊₁^{N}:

$${O}_{t + 1}^{N} = \{ {[ {O}_{t + 1 , x} ( n ) , {O}_{t + 1 , y} ( n ) ]}^{T} , 0 \leq n \leq N - 1 \} \qquad ( 18 )$$

In this case, Oₜ₊₁(n)=[O_{t+1,x}(n), O_{t+1,y}(n)]^{T} designates the n-th feature point of the set Oₜ₊₁^{N} in vector notation. The feature detection with a high threshold that is carried out in step 205 does not serve for determining the motion from image t to image t+1, but rather serves for preparing for the determination of motion from image t+1 to image t+2.

Accordingly, it is assumed hereinafter that a feature detection with a high threshold for the image t to step 205 was carried out in which a set of feature points

$${O}_{t}^{N} = \{ {[ {O}_{t , x} ( n ) , {O}_{t , y} ( n ) ]}^{T} , 0 \leq n \leq N - 1 \} \qquad ( 19 )$$

was determined.

Step 203 and step 204 are carried out using the set of feature points Oₜ^{N}.

In step 203 and step 204, a suitable affine motion determined by a matrix \hat{M}ₜ and a translation vector \hat{T}ₜ is calculated, so that for
Ôₜ₊₁^{N}=\hat{M}ₜOₜ^{N}+\hat{T}ₜ (20)
the relationship
Ôₜ₊₁^{N}⊂Pₜ₊₁^{N} (21)
holds true, where Ôₜ₊₁^{N} is the set of column vectors of the matrix Ôₜ₊₁^{N}.

In this case, Oₜ^{N} designates the matrix whose column vectors are the vectors of the set Oₜ^{N}.

This can be interpreted such that a motion is sought which maps the feature points of the image t onto feature points of the image t+1.

The determination of the affine motion is made possible by the fact that a higher threshold is used for the detection of the feature points from the set Oₜ^{N} than for the detection of the feature points from the set Pₜ₊₁^{K}.

If the same threshold is used for both detections, there is the possibility that some of the pixels corresponding to the feature points from Oₜ^{N} will not be detected as feature points at the instant t+1.

The pixel in image t+1 that corresponds to a feature point in image t is to be understood as the pixel at which the image content constituent represented by the feature point in image t is represented in image t+1 on account of the image motion.

In general, \hat{M}ₜ and \hat{T}ₜ cannot be determined such that (21) holds true, thereforee \hat{M}ₜ and \hat{T}ₜ are determined such that Oₜ^{N} is mapped onto Pₜ₊₁^{K} as well as possible by means of the affine motion in a certain sense as is defined below.

In this embodiment, the minimum distances of the points from Ôₜ^{N} to the set Pₜ₊₁^{N}, are used for a measure of the quality of the mapping of Oₜ^{N} onto Pₜ₊₁^{K}.

The minimum distance

$$\vert {D}_{min , {P}_{t + 1}^{K}} ( x , y ) \vert$$

of a point (x, y) from the set Pₜ₊₁^{K} is defined by

$$\vert {D}_{min , {P}_{t + 1}^{K}} ( x , y ) \vert = {min}_{k} \vert {[ x , y ]}^{T} - {P}_{t + 1} ( k ) \vert \qquad ( 22 )$$

The minimum distances of the points from Oₜ^{N} from the set Pₜ₊₁^{K} can be determined efficiently for example with the aid of a distance transformation, which is a morphological operation (see G. Borgefors, Distance Transformation in Digital Images, Computer Vision, Graphics and Image Processing, 34, pp. 344-371, 1986).

In the case of a distance transformation such as is described in G. Borgefors, Distance Transformation in Digital Images, Computer Vision, Graphics and Image Processing, 34, pp. 344-371, 1986, a distance image is generated from an image in which feature points are identified, in which distance image the image value at a point specifies the minimum distance to a feature point.

Clearly,

$$\vert {D}_{min , {P}_{t + 1}^{K}} ( x , y ) \vert$$

specifies for a point the distance to the point from Pₜ₊₁^{K} with respect to which the point (x, y) has the smallest distance.

The affine motion is determined in the two steps 203 and 204.

For this purpose, the affine motion formulated in (20) is decomposed into a global translation and a subsequent affine motion:
Ôₜ₊₁^{N}=\hat{M}ₜ(Oₜ^{N}+\hat{T}ₜ⁰)+\hat{T}ₜ¹ (23)

The translation vector \hat{T}ₜ⁰ determines the global translation and the matrix \hat{M}ₜ and the translation vector \hat{T}ₜ¹ determine the subsequent affine motion.

Step 203 is explained below with reference to FIG. 3.

FIG. 3 illustrates a flow diagram 300 of a determination of a translation in accordance with an exemplary embodiment of the invention.

In step 203, which is represented by step 301 of the flow diagram 300, the translation vector is determined using Pₜ₊₁^{K} and Oₜ^{N} such that

$${\hat{T}}_{t}^{0} = {arg min}_{{T}_{t}^{0}} {\sum }_{n} \vert {D}_{min , {P}_{t + 1}^{K}} ( {O}_{tx} ( n ) + {T}_{tx}^{0} , {O}_{ty} ( n ) + {T}_{ty}^{0} ) \vert \qquad ( 24 )$$

Step 301 has steps 302, 303, 304 and 305.

For the determination of \hat{T}ₜ⁰, such that equation (24) holds true, step 302 involves choosing a value T_{y}⁰ in an interval [\hat{T}_{y0}⁰, \hat{T}_{y1}⁰].

Step 303 involves choosing a value Tₓ⁰ in an interval [\hat{T}ₓ₀⁰, \hat{T}ₓ₁⁰].

Step 304 involves determining the value sum (Tₓ^{O}, T_{y}⁰) in accordance with the formula

$$sum ( {\underline{T}}_{x}^{0} , {\underline{T}}_{y}^{0} ) = {\sum }_{n} \vert {\underline{D}}_{min , {P}_{t + 1}^{K}} ( {\underline{O}}_{tx} ( n ) + {\underline{T}}_{tx}^{0} , {\underline{O}}_{ty} ( n ) + {\underline{T}}_{ty}^{0} ) \vert \qquad ( 25 )$$

for the chosen values Tₓ⁰ and T_{y}⁰.

Steps 302 to 304 are carried out for all chosen pairs of values

$${T}_{y}^{0} ∈ [ {\hat{T}}_{y 0}^{0} , {\hat{T}}_{y 1}^{0} ] and {T}_{x}^{0} ∈ [ {\hat{T}}_{x 0}^{0} , {\hat{T}}_{x 1}^{0} ] .$$

In step 305, \hat{T}_{y}⁰ and \hat{T}ₓ⁰ are determined such that sum (\hat{T}ₓ⁰, \hat{T}_{y}⁰) is equal to the minimum of all sums calculated in step 304.

The translation vector \hat{T}ₜ⁰ is given by

$${\underline{\hat{T}}}_{t}^{0} = [ {\underline{\hat{T}}}_{x}^{0} , {\underline{\hat{T}}}_{y}^{0} ] \qquad ( 26 )$$

Step 204 is explained below with reference to FIG. 4.

FIG. 4 illustrates a flow diagram 400 of a determination of an affine motion in accordance with an exemplary embodiment of the invention.

Step 204, which is represented by step 401 of the flow diagram 400, has steps 402 to 408.

Step 402 involves calculating the matrix
O′ₜ^{N}=Oₜ^{N}+\hat{T}ₜ⁰ (27)
whose column vectors form a set of points O′ₜ^{N}.

A distance vector

$${\underline{D}}_{min , {P}_{t + 1}^{K}} ( x , y )$$

is determined for each point (x, y) from the set O′ₜ^{N}.

The distance vector is determined such that it points from the point (x, y) to the point from Pₜ₊₁^{K} with respect to which the distance of the point (x, y) is minimal.

The determination is thus effected in accordance with the equations

$${k}_{min} = {arg min}_{k} \vert {[ x , y ]}^{T} - {P}_{t + 1} ( k ) \vert \qquad ( 28 )$$

$${\underline{D}}_{min , {P}_{t + 1}^{K}} ( x , y ) = {[ x . y ]}^{T} - {P}_{t + 1} ( {k}_{min} ) \qquad ( 29 )$$

The distance vectors can also be calculated from the minimum distances which are present in the form of a distance image, for example, in accordance with the following formula:

$${\underline{D}}_{min , {P}_{t + 1}^{K}} ( x , y ) = \vert {\underline{D}}_{min , {P}_{t + 1}^{K}} ( x , y ) \vert [ \begin{matrix}\frac{\partial \vert {\underline{D}}_{min , {P}_{t + 1}^{K}} ( x , y ) \vert}{\partial x} \\ \frac{\partial \vert {\underline{D}}_{min , {P}_{t + 1}^{K}} ( x , y ) \vert}{\partial y}\end{matrix} ] \qquad ( 30 )$$

In steps 403 to 408, assuming that the approximation

$${\underline{O}}_{t + 1}^{N} \approx {\underline{\tilde{O}}}_{t + 1}^{N} = {\underline{O}}_{t}^{{′}^{N}} + {\underline{D}}_{min , {P}_{t + 1}^{K}} ( {O}_{t}^{{′}^{N}} ) \qquad ( 31 )$$

holds true for the feature point set Pₜ₊₁^{N}, the affine motion is determined by means of a least squares estimation, that is, that the matrix \hat{M}ₜ and the translation vector \hat{T}ₜ¹ are determined such that the term

$${\sum }_{n} {( {\underline{\tilde{O}}}_{t + 1} ( n ) - ( {\underline{\hat{M}}}_{t}^{1} {\underline{O}}_{t}^{′} ( n ) + {\underline{\hat{T}}}_{t}^{1} ) )}^{2} \qquad ( 32 )$$

is minimal, which is the case precisely when the term

$${\sum }_{n} {( ( {\underline{O}}_{t}^{′} ( n ) + {\underline{D}}_{min , {P}_{t + 1}^{K}} ( {\underline{O}}_{t}^{′} ( n ) ) ) - ( {\underline{\hat{M}}}_{t}^{1} {\underline{O}}_{t}^{′} ( n ) + {\underline{\hat{T}}}_{t}^{1} ) )}^{2} . \qquad ( 33 )$$

is minimal.

In this case, the n-th column of the respective matrix is designated by O′ₜ(n) and Õₜ₊₁(n).

The use of the minimum distances in equation (33) can be interpreted such that it is assumed that a feature point in image t corresponds to the feature point in image t+1 which lies nearest to it, that is, that the feature point in image t has moved to the nearest feature point in image t+1.

The least squares estimation is iterated in this embodiment.

This is effected in accordance with the following decomposition of the affine motion:
\hat{M}O+\hat{T}=\hat{M}^{L}(\hat{M}^{L-1}( . . . (\hat{M}¹(O+\hat{T}⁰)+\hat{T}¹) . . . )+\hat{T}^{L-1})+\hat{T}^{L} (34)
The temporal dependence has been omitted in equation (34) for the sake of simplified notation.

That is, that L affine motions are determined, the L-th affine motion being determined in such a way that it maps the feature point set which arises as a result of progressive application of the 1^{st}, 2^{nd}, . . . and the (l-1)th affine motion to the feature point set O′ₜ^{N} onto the set Pₜ₊₁^{K}, as well as possible, in the above-described sense of the least squares estimation.

The l-th affine motion is determined by the matrix \hat{M}ₜ^{l} and the translation vector \hat{T}ₜ¹.

At the end of step 402, the iteration index 1 is set to zero and the procedure continues with step 403.

In step 403, the value of 1 is increased by 1 and a check is made to ascertain whether the iteration index 1 lies between 1 and L.

If this is the case, the procedure continues with step 404.

Step 404 involves determining the feature point set O′¹ that arises as a result of the progressive application of the 1^{st}, 2^{nd}, and the (l-1)-th affine motion to the feature point set O′ₜ^{N}.

Step 405 involves determining distance vectors analogously to equations (28) and (29) and a feature point set analogously to (31).

Step 406 involves calculating a matrix \hat{M}ₜ^{l} and a translation vector \hat{T}ₜ^{l}, which determine the l-th affine motion.

Moreover, a square error is calculated analogously to (32).

Step 407 involves checking whether the square error calculated is greater than the square error calculated in the last iteration.

If this is the case, in step 408 the iteration index 1 is set to the value L and the procedure subsequently continues with step 403.

If this is not the case, the procedure continues with step 403.

If the iteration index is set to the value L in step 408, then in step 403 the value of 1 is increased to the value L+1 and the iteration is ended.

In a one embodiment, steps 202 to 205 of the flow diagram 200 illustrated in FIG. 2 are carried out with subpixel accuracy.

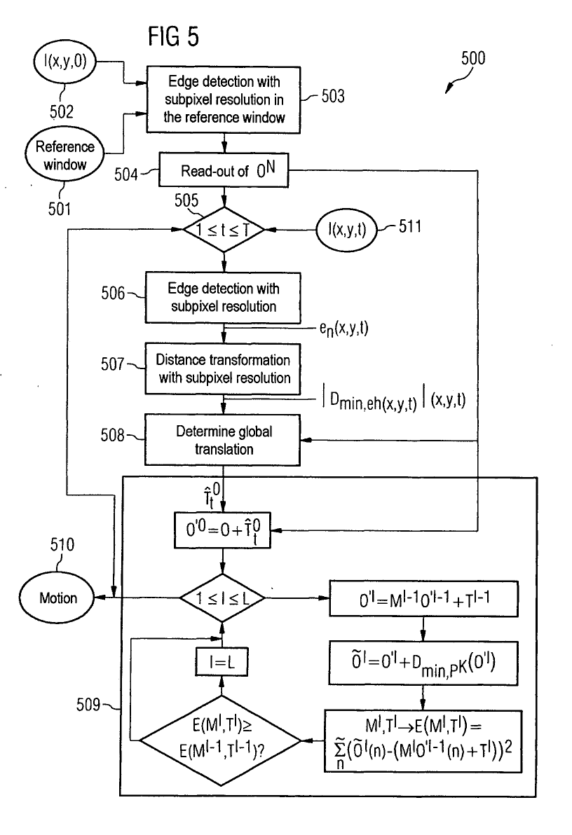

FIG. 5 illustrates a flow diagram 500 of a method in accordance with a further exemplary embodiment of the invention.

In this embodiment, a digital image that was recorded at the instant 0 is used as a reference image, which is designated hereinafter as reference window.

The coding information 502 of the reference window 501 is written hereinafter as function I(x, y, 0) analogously to the above.

Step 503 involves carrying out an edge detection with subpixel resolution in the reference window 501.

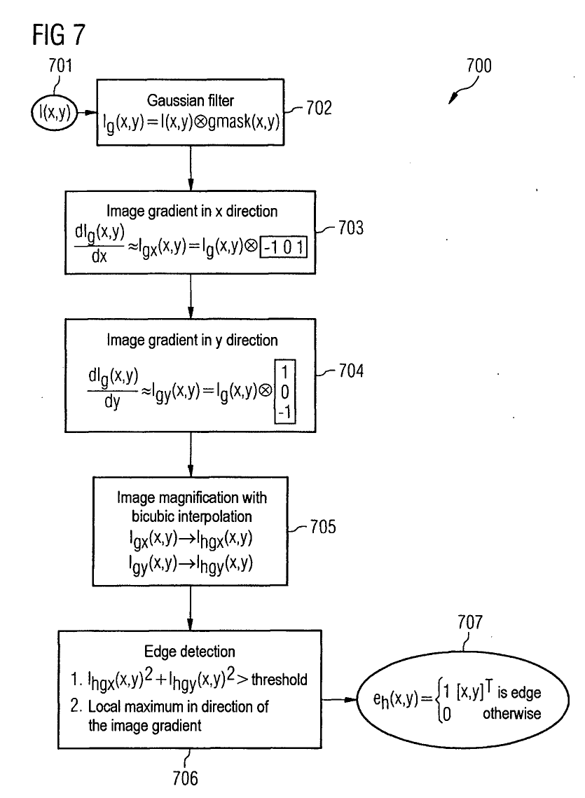

A method for edge detection with subpixel resolution in accordance with one embodiment is described below with reference to FIG. 7.

In step 504, a set of feature points ON of the reference window is determined from the result of the edge detection.

For example, the significant edge points are determined as feature points.

The time index t is subsequently set to the value zero.

In step 505, the time index t is increased by one and a check is subsequently made to ascertain whether the value of t lies between 1 and T.

If this is the case, the procedure continues with step 506.

If this is not the case, the method is ended with step 510.

In step 506, an edge detection with subpixel resolution is carried out using the coding information 511 of the t-th image, which is designated as image t analogously to the above.

This yields, as is described in greater detail below, a t-th edge image, which is designated hereinafter as edge image t, with the coding information eₕ(x, y, t) with respect to the image t.

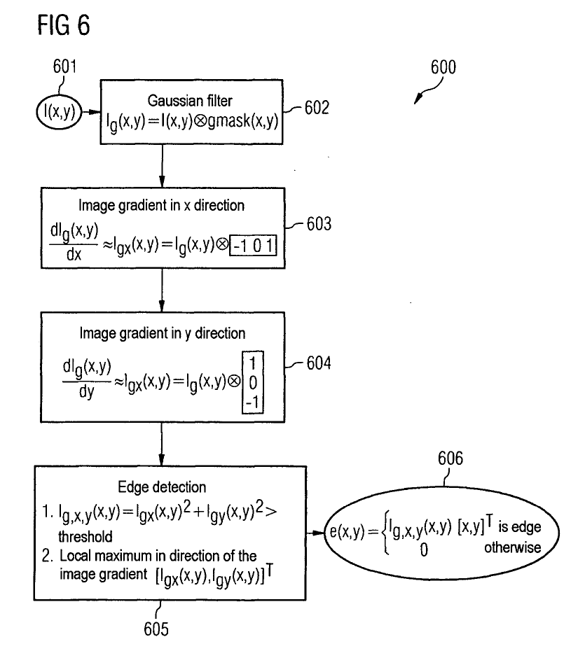

The coding information eₕ(x, y, t) of the edge image t is explained in more detail below with reference to FIG. 6 and FIG. 7.

Step 507 involves carrying out a distance transformation with subpixel resolution of the edge image t.

That is, that a distance image is generated from the edge image t, in the case of which distance image the image value at a point specifies the minimum distance to an edge point.

The edge points of the image t are the points of the edge image t in the case of which the coding information eₕ(x, y, t) has a specific value.

This is explained in more detail below.

The distance transformation is effected analogously to the embodiment described with reference to FIG. 2, FIG. 3 and FIG. 4.

In this case, use is made of the fact that the positions of the edge points of the image t were determined with subpixel accuracy in step 506.

The distance vectors are calculated with subpixel accuracy.

In step 508, a global translation is determined analogously to step 203 of the exemplary embodiment described with reference to FIG. 2, FIG. 3 and FIG. 4.

The global translation is determined with subpixel accuracy.

Parameters of an affine motion model are calculated in the processing block 509.

The calculation is effected analogously to the flow diagram illustrated in FIG. 4 as explained above.

The parameters of an affine motion model are calculated with subpixel accuracy.

After the end of the processing block 509, the procedure continues with step 505.

The method is ended if t=T, that is, if the motion of the image content between the reference window and the t-th image has been determined.

FIG. 6 illustrates a flow diagram 600 of an edge detection in accordance with an exemplary embodiment of the invention.

The determination of edges represents an expedient compromise for the motion estimation with regard to concentration on significant pixels during the motion determination and obtaining as many items of information as possible.

Edges are usually determined as local maxima in the local derivative of the image intensity. The method used here is based on the papers by Canny J. Canny, A Computational Approach to Edge Detection, IEEE Transactions on Pattern Analysis and Machine Intelligence, 6, 1986.

In step 602, a digital image in the case of which edges are intended to be detected is fitted by means of a Gaussian filter.

This is effected by convolution of the coding information 601 of the image, which is given by the function I(x, y), using a Gaussian mask designated by gmask.

Step 603 involves determining the partial derivative with respect to the variable x of the function I_{g}(x, y).

Step 604 involves determining the partial derivative with respect to the variable y of the function I_{g}(x, y).

In step 605, a decision is made as to whether an edge point is present at a point (x, y).

For this purpose, two conditions have to be met at the point (x, y).

The first condition is that the sum of the squares of the two partial derivatives determined in step 603 and step 604 at the point (x, y), designated by I_{g, x, y}(x, y) lies above a threshold value.

The second condition is that I_{g, x, y}(x, y) has a local maximum at the point (x, y).

The result of the edge detection is combined in an edge image whose coding information 606 is written as a function and designated by e(x, y).

The function e(x, y) has the value I_{g, x, y}(x, y) at a location (x, y) if it was decided with regard to (x, y) in step 605 that (x, y) is an edge point, and has the value zero at all other locations.

The approach for detecting gray-scale value corners as illustrated in FIG. 6 affords the possibility of controlling the number and the significance of the edges by means of a threshold.

It can thus be ensured that Oₜ₊₁^{N} is contained in Pₜ₊₁^{K}.

The point sets Oₜ₊₁^{N} and Pₜ₊₁^{K} can be read from the edge image having the coding information e(x, y).

If the method illustrated in FIG. 6 is used in the exemplary embodiment illustrated in FIG. 2, then for generating Pₜ₊₁^{K} from e(x, y) the threshold used in step 605 corresponds to the “low threshold” used in step 205.

For determining Oₜ₊₁^{N} using the “high threshold” used in 205, a selection is made from the edge points given by e(x, y).

This is effected for example analogously to the checking of the first condition from step 605 as explained above.

FIG. 7 illustrates a flow diagram 700 of an edge detection with subpixel accuracy in accordance with an exemplary embodiment of the invention.

Steps 702, 703 and 704 do not differ from steps 602, 603 and 604 of the edge detection method illustrated in FIG. 6.

In order to achieve a detection with subpixel accuracy, the flow diagram 700 has a step 705.

Step 705 involves extrapolating the partial derivatives in the x direction and y direction determined in step 703 and step 704, which are designated as local gradient images with coding information I_{gx}(x, y) and I_{gy}(x, y), to a higher image resolution.

The missing image values are determined by means of a bicubic interpolation. The method of bicubic interpolation is explained, for example, in William H. Press, et al., Numerical Recipes in C, ISBN: 0-521-41508-5, Cambridge University Press.

The coding information of the resulting high resolution gradient images is designated by I_{hgx}(x, y) and I_{hgy}(X, y).

Step 706 is effected analogously to step 605 using the high resolution edge images.

The coding information 707 of the edge image generated in step 706 is designated by eₕ(x, y), where the index h is intended to indicate that the edge image likewise has a high resolution.

The function eₕ(x, y) generated in step 707, in contrast to that in step 706, in this exemplary embodiment does not have the value I_{g, x, y}(x, y) if it was decided that an edge point is present at the location (x, y), but rather the value 1.

The results of a performance comparison between the method provided and known methods are explained below.

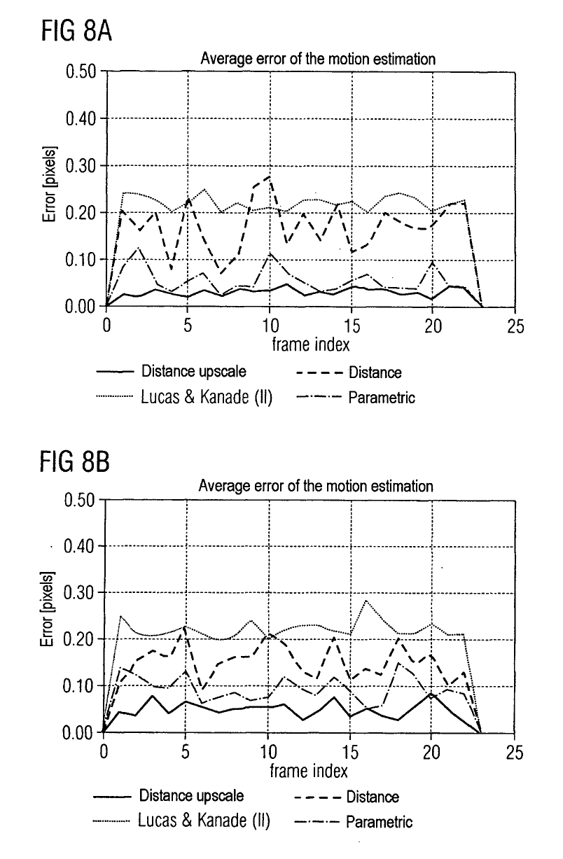

FIG. 8A and FIG. 8B illustrate the results of a performance comparison between an embodiment of the invention and known methods.

In order to generate reference data for the evaluation of the motion estimation, “camera shake” was simulated.

For this purpose, different views, that is, recordings from different camera positions, were generated by means of simulation from a high resolution image using affine transformations.

These views were subsequently filtered by means of a low-pass filter and subsampled. The sequence of digital images thus generated, which was used as an example of a sequence of digital images recorded by a moving camera, was processed by means of various methods for motion estimation.

The following reference methods were used:

1. An optical flow method based on the papers by Lucas and Kanade (see B. Lucas, T. Kanade, An Iterative Image Registration Technique with an Application to Stero Vision, 7th International Joint Conf. on Artificial Intelligence (IJCAI), pp. 674-679, 1981), using gray-scale value comers with a resolution with subpixel accuracy. The method additionally uses a resolution pyramid in order to avoid problems in the case of fast motions.

This method corresponds to the dotted line in FIG. 8A and FIG. 8B.

2. A parametric motion estimation method based on the optical flow.

This method corresponds to the dash-dotted line in FIG. 8A and FIG. 8B.

3. A method for distance-based motion estimation without improvement of the subpixel accuracy.

This method corresponds to the dashed line in FIG. 8A and FIG. 8B.

FIG. 8A illustrates the profiles of the average error of the motion estimation in an embodiment of the method provided with subpixel accuracy and the three reference methods.

The deviation between the simulated displacement and the measured displacement vectors was averaged over all pixels.

The motion of the camera was firstly simulated as a pure translation assuming ideal conditions.

FIG. 8B illustrates the profiles of the average error of the motion estimation in an embodiment of the method provided with subpixel accuracy and the three reference methods for the simulation of an affine transformation as camera motion.

The error profiles illustrated in FIG. 8A and FIG. 8B illustrate that the greatest accuracy is obtained with an embodiment of the method provided.

An overview of the required number of additions and multiplications in an embodiment of the method provided which generated the results illustrated in FIG. 8A and FIG. 8B is given below.

In addition, typical values for the number of additions and multiplications are specified for the example of a QVGA resolution.

| | Processing Steps | | | |
|---|---|---|---|---|
| | Addi- | Multipli- | Add. for | Mult. for |
| | tions | cations | QVGA | QVGA |
| Gaussian | (s_{g} − 1)2 r c | s_{g}2 r c | 1 075 200 | 153 600 |
| filter | | | | |
| Gradient | 2 r c | | 153 600 | 0 |
| filter | | | | |
| Edge | rc + 4nₑ | 2rc + | 107 520 | 192 000 |
| detection | | 5nₑ | | |
| Edges with | 9nₑ · | 9nₑ · | 29 859 840 | 13 271 040 |
| subpixel | (20 + | (12 + | | |
| accuracy | uₓu_{y}103) | uₓu_{y}45) | | |
| Distance | 8 r u_{y} c uₓ | | 2 457 600 | 0 |
| transfor- | | | | |
| mation | | | | |
| optimal | sₓs_{y}N | | 232 320 | 0 |
| trans- | | | | |
| lation | | | | |
| Affine | L (30 + | L (56 + | 460 950 | 269 080 |
| transfor- | 48N) | 28N) | | |
| mation | | | | |
| Total | | | 34 347 030 | 13 885 720 |

The definitions of the variables for the assessment of the computation time are specified in the table below.

| Variable | Meaning | Typical value |
|---|---|---|
| s_{g} | Magnitude of the Gaussian mask | s_{g} = 7 |
| r, c | Number of rows (r), number of | r = 240, c = 320 |
| | columns (c) | |
| nₑ | Number of edge points | nₑ = 0.1 r c |
| uₓ, u_{y} | Scaling factors in x and y direction | uₓ = 2, u_{y} = 2 |
| sₓ, s_{y} | Search range for optimal translation | sₓ = 11, s_{y} = 11 |
| | in x and y direction | |
| L | Number of iterations for the deter- | L = 5 |
| | mination of the affine transformation | |
| N | Number of object points (N < nₑ) | N = 0.25 |
| | | nₑ = 0.025 r c |

It is evident that the complexity for the actual motion determination is low in relation to the feature extraction with subpixel accuracy.

A feature extraction with subpixel accuracy is also required for example for the reference method specified under 3.

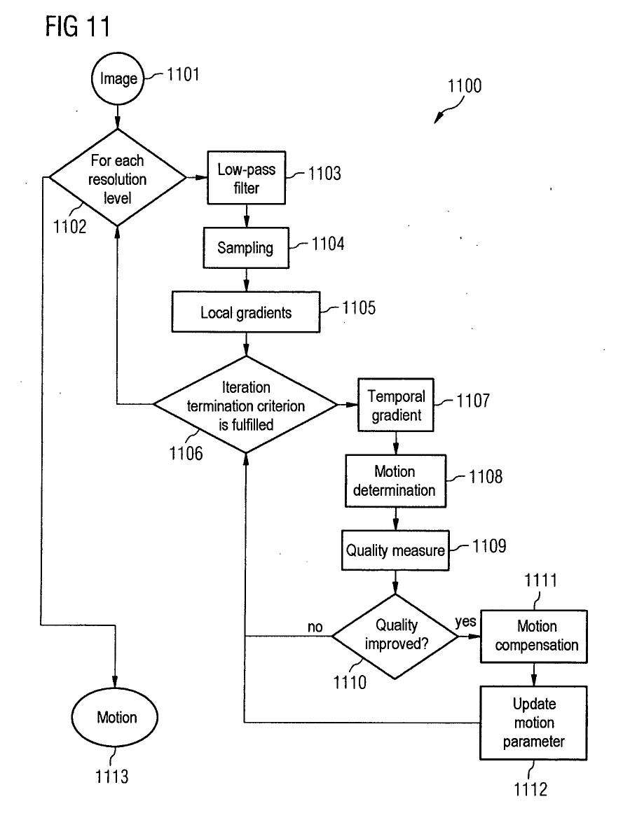

For comparison of the number of operations, the assessment was likewise carried out for the method described with reference to FIG. 11.

It was assumed in this case that 3 pyramid levels were used. On average 5 iterations were performed for each pyramid level.

It was additionally taken into account that the optical flow is only carried out at points with high significance (for example, gray-scale value edges).

The complexity for determining the significant pixels was not taken into account.

The table below shows the results of the assessment of the required number of operations.

| Processing | | | | | Add. | Mul. for |
|---|---|---|---|---|---|---|
| Steps | Iteration | Pyr. | Additions | Multiplications | QVGA | QVGA |
| Low-pass | | X | 4 r c | 2 r c | 403 200 | 201 600 |
| filter | | | | | | |
| Sampling | | X | | | 0 | 0 |
| Local | | X | 2 r c | | 201 600 | 0 |
| gradients | | | | | | |
| Temporal | x | X | rc | | 504 000 | 0 |
| gradient | | | | | | |
| Motion determination | x | X | $42 {n}_{e} + \frac{{n}_{a}^{3}}{6}$ | $46 {n}_{e} + \frac{{n}_{a}^{3}}{6}$ | 2 117 880 | 2 319 480 |
| Quality | x | X | 8nₑ | 7nₑ | 403 200 | 352 800 |
| measurement | | | | | | |
| Motion | x | X | 103rc | 45rc | 51 912 000 | 22 680 000 |
| compensation | | | | | | |
| Update motion | x | X | 8 | 12 | 120 | 180 |
| parameter | | | | | | |
| Total | | | | | 55 542 000 | 25 554 060 |

It is striking that both methods are dominated by the complexity for the interpolation of image data.

In the approach presented here, the interpolation is necessary for the edge detection with subpixel accuracy; in the reference method mentioned under 3, an interpolation is necessary for the motion compensation. A bicubic interpolation was used in both implementations.

It is evident from the assessment of the computation times that the method provided, in one embodiment, is not more complex than previously known methods even though a higher accuracy can be achieved.

The computation time for the novel method may additionally be significantly reduced if the detection of the features with subpixel accuracy is reworked.

In one embodiment, the gradient images in x and y are converted into a higher image resolution by means of a linear interpolation. In contrast to the reference method by means of optical flow, this is appropriate here since the gradient images are locally smooth on account of the low-pass filter character of the gradient filter.

In another embodiment, the interpolation is only performed at feature positions to be expected.

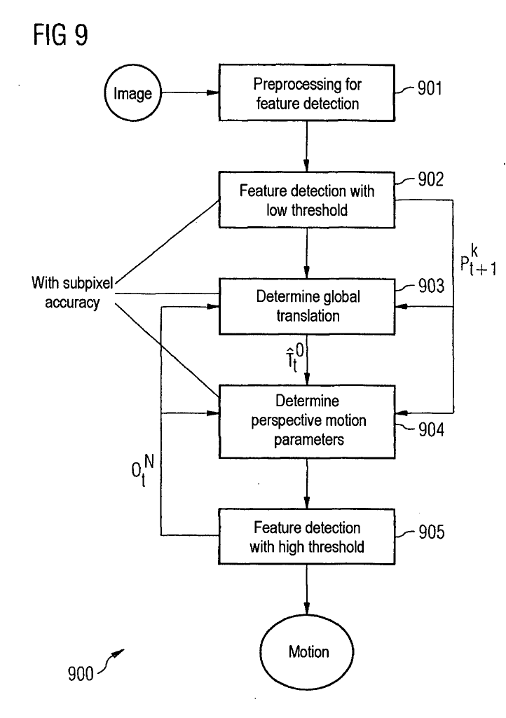

FIG. 9 illustrates a flow diagram 900 of a method in accordance with a further exemplary embodiment of the invention.

This exemplary embodiment differs from that explained with reference to FIG. 2 in that a perspective motion model is used instead of an affine motion model such as is given by equation (16), for example.

Since a camera generates a perspective mapping of the three-dimensional environment onto a two-dimensional image plane, an affine model yields only an approximation of the actual image motion which is generated by a moving camera.

If an ideal camera, that is, without lens distortions, is assumed, the motion can be described by a perspective motion model such as is given by the equation below, for example.

$$\begin{matrix}[ \begin{matrix}x ( t + dt ) \\ y ( t + dt )\end{matrix} ] = {Motion}_{pers} ( \underline{M} , x ( t ) , y ( t ) ) \\ = [ \begin{matrix}\frac{{a}_{1} x ( t ) + {a}_{2} y ( t ) + {a}_{3}}{{n}_{1} x ( t ) + {n}_{2} y ( t ) + {n}_{3}} \\ \frac{{b}_{1} x ( t ) + {b}_{2} y ( t ) + {b}_{3}}{{n}_{1} x ( t ) + {n}_{2} y ( t ) + {n}_{3}}\end{matrix} ]\end{matrix} \qquad ( 35 )$$

M designates the parameter vector for the perspective motion model.
M=[a₁, a₂, a₃, b₁, b₂, b₃, n₁, n₂, n₃] (36)

The method steps of the flow diagram 900 are analogous to those of the flow diagram 200; therefore, only the differences are discussed below.

As in the case of the method described with reference to FIG. 2, a feature point set

$${O}_{t}^{N} = \{ {[ {O}_{tx} ( n ) , {O}_{ty} ( n ) ]}^{T} , 0 \leq n \leq N - 1 \} \qquad ( 37 )$$

is present.

This feature point set represents an image excerpt or an object of the image which was recorded at the instant t.

The motion that maps O₁^{N} onto the corresponding points of the image that was recorded at the instant t+1 is now sought.

In contrast to the method described with reference to FIG. 2, the parameters of a perspective motion model are determined in step 904.

The motion model according to equation (36) has nine parameters but only eight degrees of freedom, as can be seen from the equation below.

$$\begin{matrix}[ \begin{matrix}x ( t + dt ) \\ y ( t + dt )\end{matrix} ] = [ \begin{matrix}\frac{{a}_{1} x ( t ) + {a}_{2} y ( t ) + {a}_{3}}{{n}_{1} x ( t ) + {n}_{2} y ( t ) + {n}_{3}} \\ \frac{{b}_{1} x ( t ) + {b}_{2} y ( t ) + {b}_{3}}{{n}_{1} x ( t ) + {n}_{2} y ( t ) + {n}_{3}}\end{matrix} ] \\ = [ \begin{matrix}\frac{{n}_{3}}{{n}_{3}} \frac{\frac{{a}_{1}}{{n}_{3}} x ( t ) + \frac{{a}_{2}}{{n}_{3}} y ( t ) + \frac{{a}_{3}}{{n}_{3}}}{\frac{{n}_{1}}{{n}_{3}} x ( t ) + \frac{{n}_{2}}{{n}_{3}} y ( t ) + 1} \\ \frac{{n}_{3}}{{n}_{3}} \frac{\frac{{b}_{1}}{{n}_{3}} x ( t ) + \frac{{b}_{2}}{{n}_{3}} y ( t ) + \frac{{b}_{3}}{{n}_{3}}}{\frac{{n}_{1}}{{n}_{3}} x ( t ) + \frac{{n}_{2}}{{n}_{3}} y ( t ) + 1}\end{matrix} ] = [ \begin{matrix}\frac{{a}_{1}^{′} x ( t ) + {a}_{2}^{′} y ( t ) + {a}_{3}^{′}}{{n}_{1}^{′} x ( t ) + {n}_{2}^{′} y ( t ) + 1} \\ \frac{{b}_{1}^{′} x ( t ) + {b}_{2}^{′} y ( t ) + {b}_{3}^{′}}{{n}_{1}^{′} x ( t ) + {n}_{2}^{′} y ( t ) + 1}\end{matrix} ]\end{matrix} \qquad ( 38 )$$

The parameters of the perspective model can be determined like the parameters of the affine model by means of a least squares estimation by minimizing the term

$${E}_{pers} ( {a}_{1}^{′} , {a}_{2}^{′} , {a}_{3}^{′} , {b}_{1}^{′} , {b}_{2}^{′} , {b}_{3}^{′} , {n}_{1}^{′} , {n}_{2}^{′} ) = \sum ( ( {n}_{1}^{′} {\underline{O}}_{x}^{′} ( n ) + {n}_{2}^{′} {\underline{O}}_{y}^{′} ( n ) + 1 ) ( {\underline{O}}_{x}^{′} ( n ) + {d}_{n , x} ) {- ( {a}_{1}^{′} {\underline{O}}_{y}^{′} ( n ) + {a}_{2}^{′} {\underline{O}}_{y}^{′} ( n ) + {a}_{3}^{′} ) )}^{2} + {( ( {n}_{1}^{′} {\underline{O}}_{x}^{′} ( n ) + {n}_{2}^{′} {\underline{O}}_{y}^{′} ( n ) + 1 ) ( {\underline{O}}_{y}^{′} ( n ) + {d}_{n , y} ) - ( {b}_{1}^{′} {\underline{O}}_{x}^{′} ( n ) + {b}_{2}^{′} {\underline{O}}_{y}^{′} ( n ) + {b}_{3}^{′} ) )}^{2} \qquad ( 39 )$$

In this case, O′ is defined in accordance with equation (27) analogously to the embodiment described with reference to FIG. 2.

O′ₓ(n) designates the first component of the n-th column of the matrix O′ and O′_{y}(n) designates the second component of the n-th column of the matrix O′.

The minimum distance vector

$${\underline{D}}_{min , {P}_{t + 1}^{K}} ( x , y )$$

calculated in accordance with equation (29) is designated in abbreviated fashion as [d_{n,x}d_{n,y}]^{T}.

The time index t has been omitted in formula (39) for the sake of simpler representation.

Analogously to the method described with reference to FIG. 2, in which an affine motion model is used, the accuracy can be improved for the perspective model, too, by means of an iterative procedure.

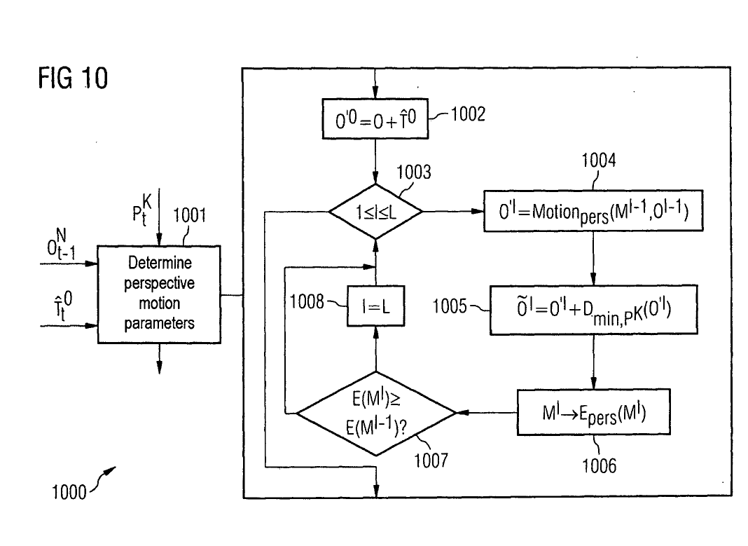

FIG. 10 illustrates a flow diagram 1000 of a determination of a perspective motion in accordance with an exemplary embodiment of the invention.

Step 1001 corresponds to step 904 of the flow diagram 900 illustrated in FIG. 9.

Steps 1002 to 1008 are analogous to steps 402 to 408 of the flow diagram 400 illustrated in FIG. 4.

The difference lies in the calculation of the error Eₚₑᵣₛ, which is calculated in accordance with equation (39) in step 1006.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. (canceled)

2-11. (canceled)

12. A method for computer-aided motion estimation in at least two temporally successive digital images with pixels to which coding information is assigned, comprising:
determining a set of feature points of the first image with subpixel accuracy using a first selection criterion, a feature point of the first image being a pixel of the first image, in the case of which the coding information which is assigned to the pixel and the coding information which is assigned in each case to the pixels in a vicinity of the pixel satisfy the first selection criterion;
determining a set of feature points of the second image with subpixel accuracy using a second selection criterion, a feature point of the second image being a pixel of the second image, in the case of which the coding information which is assigned to the pixel and the coding information which is assigned in each case to the pixels in a vicinity of the pixel satisfy the second selection criterion;
determining an assignment of each feature point of the first image to a respective feature point of the second image on the basis of the spatial distribution of the set of feature points of the first image and on the basis of the spatial distribution of the set of feature points of the second image; and
estimating the motion with subpixel accuracy on the basis of the assignment.

13. The method of claim 12, further including assigning a feature point from the set of feature points of the first image to a feature point from the set of feature points of the second image with respect to which the feature point from the set of features of the first image has a minimum spatial distance which is determined from the coordinates of the feature point from the set of feature points of the first image and the coordinates of the feature point from the set of feature points of the second image.

14. The method of claim 12, further including effecting the motion estimation by determination of a motion model.

15. The method of claim 14, further including determining a translation prior to determining the motion model.

16. The method of claim 14, wherein the motion model is one of an affine motion model and a perspective motion model.

17. The method of claim 14, further including determining the motion model iteratively.

18. The method of claim 12, further including choosing the first selection criterion and the second selection criterion such that the feature points from the set of feature points of the first image are edge points of the first image and the feature points from the set of feature points of the second image are edge points of the second image.

19. The method of claim 12, which is used in the case of one of a structure-from-motion method, a method for generating mosaic images, a video compression method and a super-resolution method.

20. A computer program element, which, after it has been loaded into a memory of a computer, has the effect that the computer carries out a method for computer-aided motion estimation in at least two temporally successive digital images with pixels to which coding information is assigned, comprising:
determining a set of feature points of the first image with subpixel accuracy using a first selection criterion, a feature point of the first image being a pixel of the first image, in the case of which the coding information which is assigned to the pixel and the coding information which is assigned in each case to the pixels in a vicinity of the pixel satisfy the first selection criterion;
determining a set of feature points of the second image with subpixel accuracy using a second selection criterion, a feature point of the second image being a pixel of the second image, in the case of which the coding information which is assigned to the pixel and the coding information which is assigned in each case to the pixels in a vicinity of the pixel satisfy the second selection criterion;
determining an assignment of each feature point of the first image to a respective feature point of the second image on the basis of the spatial distribution of the set of feature points of the first image and on the basis of the spatial distribution of the set of feature points of the second image; and
estimating the motion with subpixel accuracy on the basis of the assignment.

21. A computer-readable storage medium, on which a program is stored which enables a computer, after it has been loaded into a memory of the computer, to carry out a method for computer-aided motion estimation in at least two temporally successive digital images with pixels to which coding information is assigned, comprising:
determining a set of feature points of the first image with subpixel accuracy using a first selection criterion, a feature point of the first image being a pixel of the first image, in the case of which the coding information which is assigned to the pixel and the coding information which is assigned in each case to the pixels in a vicinity of the pixel satisfy the first selection criterion;
determining a set of feature points of the second image with subpixel accuracy using a second selection criterion, a feature point of the second image being a pixel of the second image, in the case of which the coding information which is assigned to the pixel and the coding information which is assigned in each case to the pixels in a vicinity of the pixel satisfy the second selection criterion;
determining an assignment of each feature point of the first image to a respective feature point of the second image on the basis of the spatial distribution of the set of feature points of the first image and on the basis of the spatial distribution of the set of feature points of the second image; and estimating the motion with subpixel accuracy on the basis of the assignment.

22. A device for computer-aided motion estimation in at least two temporally successive digital images with pixels to which coding information is assigned, comprising:
means for determining a set of feature points of the first image with subpixel accuracy using a first selection criterion, a feature point of the first image being a pixel of the first image, in the case of which the coding information which is assigned to the pixel and the coding information which is assigned in each case to the pixels in a vicinity of the pixel satisfy the first selection criterion;
means for determining a set of feature points of the second image with subpixel accuracy using a second selection criterion, a feature point of the second image being a pixel of the second image, in the case of which the coding information which is assigned to the pixel and the coding information which is assigned in each case to the pixels in a vicinity of the pixel satisfy the second selection criterion;
means for determining an assignment of each feature point of the first image to a respective feature point of the second image on the basis of the spatial distribution of the set of feature points of the first image and on the basis of the spatial distribution of the set of feature points of the second image; and
means for estimating the motion with subpixel accuracy on the basis of the assignment.

23. The device of claim 22, further comprising means for assigning a feature point from the set of feature point from the set of feature points of the first image to a feature point from the set of feature points of the second image with respect to which the feature point from the set of features of the first image has a minimum spatial distance which is determined from the coordinates of the feature point from the set of feature points of the first image and the coordinates of the feature point from the set of feature points of the second image.

24. The device of claim 22, further comprising means for effecting the motion estimation by determining a motion model.

25. The device of claim 24, further comprising means for determining a translation prior to determining the motion model.

26. The device of claim 24, wherein the motion model is one of an affine motion model and a perspective motion model.

27. The device of claim 24, further comprising means for determining the motion model iteratively.

28. The device of claim 22, further comprising means for choosing the first selection criterion and the second selection criterion such that the feature points from the set of feature points of the first image are edge points of the first image and the feature points from the set of feature points of the second image are edge points of the second image.

29. The device of claim 22, which is used in the case of one of a structure-from-motion method, a method for generating mosaic images, a video compression method and a super-resolution method.
